(19) United States
(12) Patent Application Publication
(10) Pub. No.: US 2026/0044313 A1
(43) Pub. Date: Feb. 12, 2026

(54) SYSTEM AND METHOD FOR PASSING DETERMINED PARAMETERS IN ARTIFICIAL INTELLIGENCE ASSISTANT FLOWS

(71) Applicant: Workato, Inc., Palo Alto, CA (US)

(72) Inventor: Mark Poroshin, Tbilisi (GE)

(21) Appl. No.: 19/298,001

(22) Filed: Aug. 12, 2025

Related U.S. Application Data
(60) Provisional application No. 63/682,226, filed on Aug. 12, 2024.

(51) Int. Cl. G06F 8/20; G06F 8/38

(52) U.S. Cl. CPC G06F 8/20; G06F 8/38

(57) ABSTRACT

A system may generate a software recipe, which includes triggers and actions where the actions include one or more function tool calls. The system may determine a first set of parameters for the one or more function tool calls and a second set of parameters for the one or more function tool calls, where the first set of parameters is withheld from one or more artificial intelligence (AI) models and the second set of parameters is determined by the one or more AI models. In some implementations, the system may merge the first set of parameters and the second set of parameters for the one or more function tool calls, which use the first set of parameters and the second set of parameters to perform the one or more actions, and the system may execute the software recipe using the one or more function tool calls.

### BACKGROUND

The present disclosure relates to a platform for improving interaction with artificial intelligence (AI) models. For instance, the disclosure relates to a system and method for passing determined parameters in AI flows.

Recently, large language models (LLMs) and other AI assistants have become very popular tools for performing natural language processing and inference of data. The ability of these AI assistants to receive an unstructured prompt, infer a structure, receive structured data via prompts, and then return natural language responses can be very beneficial in interacting with humans. Unfortunately, due to the extremely large compute required to train the models, they tend to only be able to answer prompts using months or years old public data.

Recently, AI assistants have used function calls to request structured data via an application programming interface (API) thereby allowing them to use more up-to-date or even private data to generate natural language prompts.

As each interaction with an AI assistant via this method uses multiple interactions on the back end, they can quickly use significant processing, bandwidth, and/or tokens. The transfer of data back and forth using these traditional function calls, especially for complex parameters, used significant quantities of tokens and therefore computer resources and/or cost, especially when automating repetitive tasks or generating code. Previous systems sometimes also resulted in non-deterministic and error-prone behaviors, were slow, and had other issues.

Additionally, because local data may be returned to the AI assistant, there is a possibility that private data could be shared externally, for example, with the AI assistant or another party. Data security policies, privacy policies, and regulations may prevent such data from being transferred from a first-party server to that of an AI assistant. Accordingly, previous methods of using AI assistants either did not allow use of local data or required substantial local compute for a local AI assistant in order to preserve data security.

Finally, previous systems required manual setup and coding, which prevented them from being commonly used by individuals without the coding ability or time to set them up.

### SUMMARY

This disclosure describes technology that addresses the above-noted deficiencies of existing solutions by providing technology for a system and method for passing determined parameters in artificial intelligence assistance flows, among other improvements. In some aspects, the techniques described herein relate to a computer-implemented method including: generating, by one or more processors, a software recipe, the software recipe including one or more triggers and one or more actions, at least one of the one or more actions including one or more function tool calls; determining, by the one or more processors, a first set of parameters for the one or more function tool calls; determining, by the one or more processors, a second set of parameters for the one or more function tool calls, the second set of parameters being determined by one or more artificial intelligence (AI) models; merging, by the one or more processors, the first set of parameters and the second set of parameters for the one or more function tool calls, the one or more function tool calls using the first set of parameters and the second set of parameters to perform the one or more actions; and executing, by the one or more processors, the software recipe using the one or more function tool calls.

In some aspects, the techniques described herein relate to a computer-implemented method, further including: receiving, by the one or more processors, a prompt requesting a generation of the software recipe; processing, by the one or more processors, the prompt including stripping data from the prompt; and relaying, by the one or more processors, the processed prompt to the one or more AI models to determine user intent for the software recipe.

In some aspects, the techniques described herein relate to a computer-implemented method, further including: receiving, by the one or more processors, the software recipe from the one or more AI models; displaying, by the one or more processors, a graphical representation of the software recipe to a user in a graphical user interface; and receiving, by the one or more processors, an approval of the software recipe by the user.

In some aspects, the techniques described herein relate to a computer-implemented method, wherein stripping the data from the prompt includes: removing, by the one or more processors, at least one parameter of the first set of parameters from the prompt.

In some aspects, the techniques described herein relate to a computer-implemented method, further including: determining, by the one or more processors, an output for a previous function tool call; determining, by the one or more processors, the first set of parameters based on the output for the previous function tool call; and using, by the one or more processors, the first set of parameters in an input for the one or more function tool calls.

In some aspects, the techniques described herein relate to a computer-implemented method, wherein: the first set of parameters includes one or more data points defined to be restricted from being accessed by the one or more AI models.

In some aspects, the techniques described herein relate to a computer-implemented method, wherein: the first set of parameters includes a user identifier used in the software recipe, the one or more processors determining the user identifier at run time of the software recipe.

In some aspects, the techniques described herein relate to a computer-implemented method, wherein: the first set of parameters includes one or more previously defined parameters by the one or more AI models for a previous software recipe, the one or more previously defined parameters defining a connection with a separate application.

In some aspects, the techniques described herein relate to a computer-implemented method, wherein executing the software recipe using the one or more function tool calls includes: performing, by the one or more processors, post processing on a response from the one or more AI models using a previously determined parameter, the first set of parameters including the previously determined parameter.

In some aspects, the techniques described herein relate to a computer-implemented method, wherein executing the software recipe using the one or more function tool calls includes: injecting, by the one or more processors, the first set of parameters into the one or more function tool calls.

In some aspects, the techniques described herein relate to a system including: one or more processors; and a computer-readable memory storing instructions that, when executed by the one or more processors, cause the system to perform operations including: generating, by the one or more processors, a software recipe, the software recipe including one or more triggers and one or more actions, at least one of the one or more actions including one or more function tool calls; determining, by the one or more processors, a first set of parameters for the one or more function tool calls; determining, by the one or more processors, a second set of parameters for the one or more function tool calls, the second set of parameters being determined by one or more artificial intelligence (AI) models; merging, by the one or more processors, the first set of parameters and the second set of parameters for the one or more function tool calls, the one or more function tool calls using the first set of parameters and the second set of parameters to perform the one or more actions; and executing, by the one or more processors, the software recipe using the one or more function tool calls.

In some aspects, the techniques described herein relate to a system, wherein the operations further include: receiving, by the one or more processors, a prompt requesting a generation of the software recipe; processing, by the one or more processors, the prompt including stripping data from the prompt; and relaying, by the one or more processors, the processed prompt to the one or more AI models to determine user intent for the software recipe.

In some aspects, the techniques described herein relate to a system, wherein the operations further include: receiving, by the one or more processors, the software recipe from the one or more AI models; displaying, by the one or more processors, a graphical representation of the software recipe to a user in a graphical user interface; and receiving, by the one or more processors, an approval of the software recipe by the user.

In some aspects, the techniques described herein relate to a system, wherein stripping the data from the prompt includes: removing, by the one or more processors, at least one parameter of the first set of parameters from the prompt.

In some aspects, the techniques described herein relate to a system, wherein the operations further include: determining, by the one or more processors, an output for a previous function tool call; determining, by the one or more processors, the first set of parameters based on the output for the previous function tool call; and using, by the one or more processors, the first set of parameters in an input for the one or more function tool calls.

In some aspects, the techniques described herein relate to a system, wherein: the first set of parameters includes one or more data points defined to be restricted from being accessed by the one or more AI models.

In some aspects, the techniques described herein relate to a system, wherein: the first set of parameters includes a user identifier used in the software recipe, the one or more processors determining the user identifier at run time of the software recipe.

In some aspects, the techniques described herein relate to a system, wherein: the first set of parameters includes one or more previously defined parameters by the one or more AI models for a previous software recipe, the one or more previously defined parameters defining a connection with a separate application.

In some aspects, the techniques described herein relate to a system, wherein executing the software recipe using the one or more function tool calls includes: performing, by the one or more processors, post processing on a response from the one or more AI models using a previously determined parameter, the first set of parameters including the previously determined parameter.

In some aspects, the techniques described herein relate to a system, wherein executing the software recipe using the one or more function tool calls includes: injecting, by the one or more processors, the first set of parameters into the one or more function tool calls.

Other implementations of one or more of these aspects or other aspects include corresponding systems, apparatus, and computer programs, configured to perform the various actions and/or store various data described in association with these aspects. These and other implementations, such as various data structures, are encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1 is a block diagram illustrating an example integration management system encompassed by the technology.

FIG. 2 is a block diagram of an example computing system.

FIG. 3 illustrates an example method for passing parameters in artificial intelligence flows.

FIG. 4 illustrates a flowchart of example operations for passing determined parameters in artificial intelligence assistant flows.

### DETAILED DESCRIPTION

The innovative technology disclosed in this application is capable of, for instance, improving interaction with artificial intelligence (AI) models. For instance, the disclosure relates to a system and method for passing determined parameters in AI flows.

The technologies herein may be used in numerous contexts, such as in an AI work genie or agent that receives prompts, creates tickets, and sets up automations to execute tasks. An example is in an AI copilot which provides an interactive service for a continuing conversation with a client. The technology may be used in interactions with AI assistants or large language models (LLMs) via application programming interfaces (APIs), directly in prompts, or otherwise. In some implementations, the technology may be configured to execute functions on behalf of a user so it can both research what function is appropriate and then execute that function on the user's behalf. In some implementations, the system may use one or more first-party applications or systems (referred to herein as a workflow copilot 140) to interact with a separate AI assistant or LLM, for example, via an API. These technologies may be triggered by user input or may operate autonomously (e.g., based on monitoring defined triggers), potentially including connecting to one or multiple external services and communicating with one or multiple users.

The technology described herein may improve over the systems in the Background, for example, by using fewer tokens, shortening prompts, leveraging past interactions, increasing data security, improving connections, increasing efficiency, increasing accuracy, and/or other improvements. For instance, the technology makes using an AI assistant with external tools or functions more secure, faster, cheaper, and more deterministic, especially as part of a function calling mechanism. The technology may decrease the number of tokens used by an LLM, provide faster and cheaper operations inside complex AI assistant flows, and decrease potential errors.

For example, in some implementations, an AI assistant flow uses parameters determined by an LLM to be passed in a form of function call. The technology described herein adds an additional or alternative method of passing parameters, such as those determined by previous calls or other operations. For example, the technology may modify mechanisms of function calling by adding a set of parameters that merge with LLM-defined parameters. The technology may include a method of working with parameters in complex AI flows by storing separate state(s) outside of LLM calls and merging stored state(s) with LLM-defined parameters.

As an example, an AI chat API may allow a user to interact with an alarm and have the event call a tool. Generating and using such a software recipe may require passing many parameters to generate the recipe, such as user intent, which connections to use, or other information used by the recipe. The generation may lead to a chain of two calls, for example, first to generate a flow, then to fill the input fields of each block of the flow. In order to generate a functional recipe, the technology may take the result of a first tool and pass it to a second tool. For example, it may use an LLM to pass the result of one tool to a second tool including configuring the next tool.

A function or tool may include connections to another service in order to provide actions or skills, such as updating a ServiceNow™ ticket, creating an opportunity in Salesforce™, or accessing a knowledge base to get more context, for example. Tools may have connection details, APIs, parameters, inputs, outputs, or otherwise.

The technology herein may beneficially divide arguments into the two sets where a first set includes the arguments that should be configured by the LLM (e.g., user intent, information that is not extracted by a workflow copilot 140, for example, from an output of a previous tool, etc.). A second set of arguments may include deterministic arguments, such as a JSON (JavaScript object notation) representation of a recipe, a set of connectors, or other parameters that the workflow copilot 140 may not pass in the prompt to the LLM (AI assistant and LLM are used interchangeably herein, but it should be noted that other models and implementations are possible). For instance, the workflow copilot 140 may pass the second set of parameters/arguments directly to a tool in a function or tool call.

Accordingly, the workflow copilot 140 may hide some information (e.g., sensitive data, IDs, passwords, security tokens, etc.), from the LLM, which saves tokens (e.g., tokens of processing by the LLM) and improves data security, for example, where not an entire JSON file for a recipe is passed to the LLM. In some implementations, the workflow copilot 140 may automatically use data from previous calls and/or tools for future calls and/or tools, such as by taking the output from a first tool and putting it into an input of a second tool without necessarily passing some or all of this data through the LLM. For instance, by reducing the data submitted to the LLM, bandwidth, processing, and tokens can be reduced while also improving data security.

In some implementations, the LLM or AI assistant may be interchangeable, so that the technology may be used with different LLMs/AI assistants (e.g., OpenAI™, Gemini™, Llama™, Claude™, or other models). In some implementations, such as where the API for tools cannot be passed to the LLM, previous technologies were unable to deploy services. The technologies described herein may separate out the parameters for some tools, connections, or data, which may solve these previous issues, among providing other benefits noted herein.

The technology may include code and interfaces for generating and updating recipes (e.g., low code automations), workflows, code, integrations automations, etc., using an AI assistant. The technology may include using an AI agent to create an outline or sketch of an overall workflow for accomplishing an automated task. Once the outline of the workflow is established, the AI may then go through the outline step by step to generate code and associated information for the steps. The technology may allow a user to converse with an AI assistant to generate new workflows or update existing workflows by allowing rapidly iterating updates to a proposed outline or sketch. The technology may provide ways for users to interface with an AI assistant to build workflows faster while achieving better results.

These and other benefits, operations, and features are described by way of example in the implementations herein. It should be noted that while certain examples are provided, these are not exhaustive, and others are possible and contemplated herein.

With reference to the figures, reference numbers may be used to refer to components found in any of the figures, regardless of whether those reference numbers are shown in the figures being described. Further, where a reference number includes a letter referring to one of multiple similar components (e.g., component 000a, 000b, and 000n), the reference number may be used without the letter to refer to one or all of the similar components.

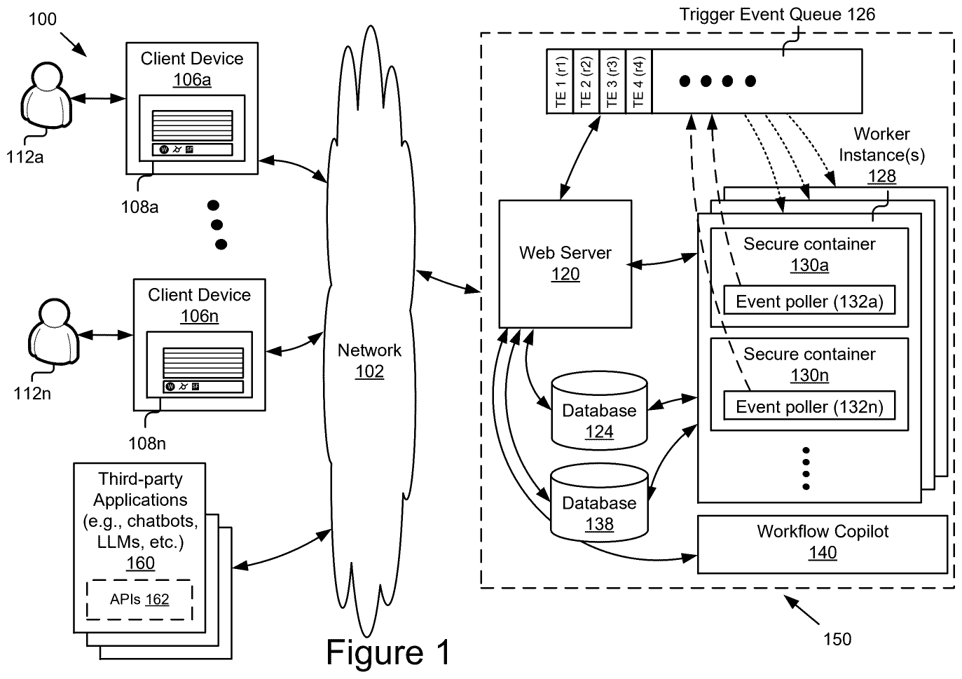

FIG. 1 is a block diagram illustrating an example system 100 in which the technology may be used. The illustrated example system 100 includes client devices 106a . . . 106n, a server system 150, and third-party applications 160, which are communicatively coupled via a network 102 for interaction with one another. For example, the client devices 106a . . . 106n may be respectively coupled to the network 102 and may be accessible by users 112a . . . 112n (also referred to individually and collectively as 112). The server system 150 and third-party applications 160 may be communicatively coupled to the network 102. The use of the nomenclature “a” and “n” in the reference numbers indicates that any number of those elements having that nomenclature may be included in the system 100. The architecture, location of services, and other features are described by way of example.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless networking software and/or hardware that interconnects the computing devices of the system 100. For example, the network 102 may include packet-switching devices that route the data packets to the various computing devices based on information included in a header of the data packets.

The client devices 106a . . . 106n (also referred to individually and collectively as 106) include computing systems having data processing and communication capabilities. In some implementations, a client device 106 may include a processor (e.g., virtual, physical, etc.), a memory, a power source, a network interface, and/or other software and/or hardware components, such as a display, graphics processor, wireless transceivers, keyboard, camera, sensors, firmware, operating systems, drivers, and/or various physical connection interfaces (e.g., USB, HDMI, etc.), etc. The client devices 106a . . . 106n may couple to and communicate with one another and the other entities of the system 100 via the network 102 using a wireless and/or wired connection.

Examples of client devices 106 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing systems.

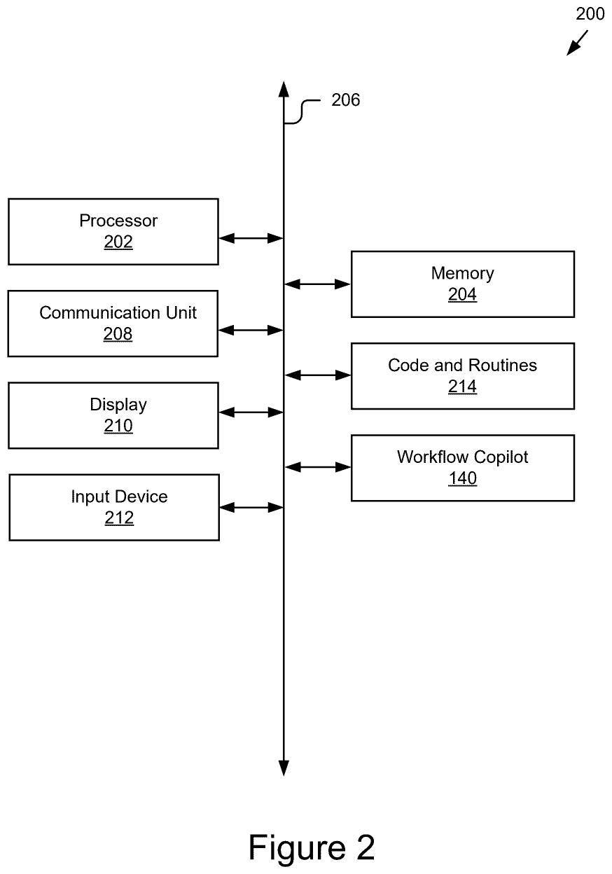

In the depicted implementation, the client devices 106a . . . 106n respectively contain instances 108a . . . 108n of a client application (also referred to individually and collectively as 108). The client application 108 may be storable in a memory (e.g., see FIG. 2) and executable by a processor (e.g., see FIG. 2) of a client device 106 to provide for user interaction, receive user input, present information to the user via a display (e.g., see FIG. 2), and send data to and receive data from the other entities of the system 100 via the network 102. Examples of various interfaces that can be rendered and presented by the client application 108 are depicted herein. In some implementations, the client application 108 may present or interact with a chat application or conversational interface operable on a third-party server (not shown) and/or on the server system 150.

In some implementations, the client application 108 may generate and present various user interfaces to perform these acts and/or functionality, such as the example graphical user interfaces discussed elsewhere herein, which may, in some cases, be based at least in part on information received from local storage, the server system 150, and/or one or more of the third-party applications 160 via the network 102. In some implementations, the client application 108 is code operable in a web browser, a native application (e.g., mobile app), a combination of both, etc. Additional structure, acts, and/or functionality of the client devices 106 and the client application 108 are described in further detail elsewhere in this document.

In some implementations, the client application 108 may include or communicate with the workflow copilot 140, as described in further detail below. For instance, the client application 108 may incorporate some or all of the functionality described in reference to the workflow copilot 140.

The server system 150, a third-party server (not shown), and/or the third-party applications 160 may include one or more computing systems having data processing, storing, and communication capabilities. For example, these entities 150 and/or 160 may include one or more hardware servers, virtual servers, server arrays, storage devices and/or systems, etc., and/or may be centralized or distributed/cloud based. In some implementations, these entities 150 and/or 160 may include one or more virtual servers, which operate in a host server environment and access the physical hardware of the host server including, for example, a processor, memory, storage, network interfaces, etc., via an abstraction layer (e.g., a virtual machine manager).

In the depicted implementation, the server system 150 includes a web server 120, a trigger event queue 126, databases 124 and 138, worker instances 128, and a workflow copilot 140. These components, and their sub-components, are coupled for electronic communication with one another, and/or the other elements of the system 100. In some instances, these components may communicate via direct electronic connections or via a public and/or private computer network, such as the network 102.

In some embodiments, a worker instance 128 represents a worker compute node and may include more than one secure container 130a . . . 130n, as shown in FIG. 1. A container in the worker instance 128, at a given time, may run a recipe. A container may add trigger events to the trigger event queue 126 and (responsive to the trigger event being triggered) receive events from the trigger event queue 126. The event poller 132 (multiple instances 132a . . . 132n are shown) is software configured to poll for messages indicating the completion of a prior call so the secure container can proceed to the next step of the recipe (or to completion as the case may be). The server system 150 may utilize any suitable runtime environment and process queue/worker architecture, such as Heroku™.

The web server 120 includes computer logic executable by the processor 202 (see FIG. 2) to process content requests. The web server 120 may include an HTTP server, a REST (representational state transfer) service, or other suitable server type. The web server 120 may receive content requests (e.g., product search requests, HTTP requests, commands, etc.) from client devices 106, cooperate with the other components of the server system 150 (e.g., workflow copilot 140, worker instances 128, trigger event queue 126, etc.) to determine the content and or trigger processing, retrieve and incorporate data from the databases 124 and 138, format the content, and provide the content to the client devices 106. In some instances, the web server 120 may format the content using a web language and provide the content to a corresponding client application 108 for processing and/or rendering to the user for display. The web server 120 may be coupled to the databases 124 and 138 to store retrieve, and/or manipulate data stored therein.

In some embodiments, the components 108, 120, 128, 126, and/or 140 may include computer logic storable in the memory 204 and executable by the processor 202, and/or implemented in hardware (e.g., ASIC, FPGA, ASSP, SoC, etc.), to provide their acts and/or functionality. For example, with reference also to FIG. 2, in some embodiments, the client application 108, the web server 120, the worker instances 128, the trigger event queue 126, and/or the workflow copilot 140, and/or their sub-modules are sets of instructions executable by the processor 202 to provide their functionality. In some embodiments, these components and/or their sub-components are stored in the memory 204 of the computing system 200 and are accessible and executable by the processor 202 to provide their functionality. In any of the foregoing embodiments, these components and/or their sub-components may be adapted for cooperation and communication with the processor 202 and other components of the computing system 200.

The databases 124 and 138 are information sources for storing and providing access to data. Examples of the types of data stored by the databases 124 and 138 may include user and partner account information, code representing the recipes, requirement tables associated with the code, input and output schemas associated with the code and/or applications, event data, metadata, objects associated with the applications, code, and/or schemas, etc., and/or any of the other data discussed herein that is received, processed, stored, or provided by the integration management system 100. Recipes may be associated with a user's account.

As noted elsewhere herein, in some implementations, various placeholders, private information, or other data used in the technology described herein may be stored in the database(s) 124 and 138, for example, so that private information may be securely stored and used without necessarily sending that private information to an external service, such as a third-party application 160. It should be noted that private information may be maintained otherwise, such as on a client device 106 to further improve data security.

The databases 124 and 138 may be included in the computing system 200 or in another computing system and/or storage system distinct from but coupled to or accessible by the computing system 200. The databases 124 and 138 can include one or more non-transitory computer-readable mediums for storing the data. In some implementations, the databases 124 and 138 may be incorporated with the memory 204 or may be distinct therefrom. In some implementations, the databases 124 and 138 may include a database management system (DBMS) operable on the computing system 200. For example, the DBMS could include a structured query language (SQL) DBMS, a NoSQL DBMS, various combinations thereof, etc. In some instances, the DBMS may store data in multi-dimensional tables comprised of rows and columns, and manipulate, i.e., insert, query, update and/or delete, rows of data using programmatic operations.

The third-party applications 160a . . . 160n, as depicted, may respectively expose APIs 162 for accessing the functionality and data of the third-party applications 160a . . . 160n (also referred to individually and collectively as 160). An application 160 may include hardware (e.g., a server) configured to execute software, logic, and/or routines to provide various services (consumer, business, etc.), such as video, music and multimedia hosting, distribution, and sharing; email; social networking; blogging; micro-blogging; photo management; cloud-based data storage and sharing; ERM; CRM; financial services; surveys; marketing; analytics; a combination of one or more of the foregoing services; or any other service where users store, retrieve, collaborate, generate, consume, and/or share information.

In some implementations, the third-party applications 160 may include messaging services, artificial intelligence models, chatbots, or other services. For example, in some implementations, the third-party application 160 may include one or more artificial intelligence agents or large language models that receive textual or other inputs and, based on training, determine intent, generate outputs, etc. For instance, some large language models may include Llama™, Gemini™, ChatGPT™, Claude™, etc., that may be hosted on a first-party or third-party server. These or other models may be tuned using user or company specific data, such as previous code, workflows, recipes, etc., which may be generated in a training and/or verification dataset.

In some implementations, the client application 108, the various components of the server system 150, the third-party applications 160, etc., may require users 112 to be registered to access the acts and/or functionality provided by them. For example, to access various acts and/or functionality provided by these components, the components may require a user 112 to authenticate his/her identity (e.g., by confirming a valid electronic address or other information). In some instances, these entities 108, 120, 140, 160, etc., may interact with a federated identity server (not shown) to register/authenticate users 112. Once registered, these entities may require a user 112 seeking access to authenticate by inputting credentials in an associated user interface.

The system 100 illustrated in FIG. 1 may be representative of an example system for collaborative design, and it should be understood that a variety of different system environments and configurations are contemplated and are within the scope of the present disclosure. For instance, various functionality may be moved from a server to a client, or vice versa and some implementations may include additional or fewer computing systems, services, and/or networks, and may implement various functionality client or server-side. Further, various entities of the system 100 may be integrated into a single computing device or system or additional computing devices or systems, etc.

Additional acts, structure, and/or functionality of the client devices 106, server system 150, third-party applications 160, and their constituent components are described in further detail below.

FIG. 2 is a block diagram of an example computing system 200. The example computing system 200 may represent the computer architecture of a client device 106, a server system 150, a server of a conversational interface application, a server or computing device of a workflow copilot 140, and/or a server of the third-party application 160, or components, depending on the implementation. As depicted, the computing system 200 may include a processor 202, a memory 204, a communication unit 208, a display 210, and an input device 212, which may be communicatively coupled by a communications bus 206. The computing system 200 depicted in FIG. 2 is provided by way of example and it should be understood that it may take other forms and include additional or fewer components without departing from the scope of the present disclosure. For instance, various components of the computing devices and may be coupled for communication using a variety of communication protocols and/or technologies including, for instance, communication buses, software communication mechanisms, computer networks, etc.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual and may include a single core or plurality of processing units and/or cores. In some implementations, the processor 202 may be capable of generating and providing electronic display signals to a display device, supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the computing system 200 including, for example, the memory 204, the communication unit 208, display 210, and the input device 212.

The memory 204 may store and provide access to data to the other components of the computing system 200. The memory 204 may be included in a single computing device or a plurality of computing devices as discussed elsewhere herein. In some implementations, the memory 204 may store instructions and/or data that may be executed by the processor 202. For example, the memory 204 may include various different combinations of the software components described herein, depending on the configuration. The memory 204 is also capable of storing other instructions and data, including, for example, an operating system, hardware drivers, other software applications, databases, etc. The memory 204 may be coupled to the bus 206 for communication with the processor 202 and the various other components of the computing system 200.

The memory 204 includes a non-transitory computer-usable (e.g., readable, writeable, etc.) medium, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blu-ray™, etc.). It should be understood that the memory 204 may be a single device or may include multiple types of devices and configurations.

The bus 206 can include a communication bus for transferring data between components of a computing system or between computing systems, a network bus system including the network 102 and/or portions thereof, a processor mesh, a combination thereof, etc. In some implementations, the various components of the system 100 may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and/or wireless connectivity with the network 102 and/or other computing systems. For instance, the communication unit 208 may include, but is not limited to, CAT-type interfaces; wireless transceivers for sending and receiving signals using Wi-Fi™, Bluetooth®, IrDA™, Z-Wave™, ZigBee®, cellular communications, and the like, etc. ; USB interfaces; various combinations thereof; etc. The communication unit 208 may connect to and send/receive data via a mobile network, a public IP network of the network 102, a private IP network of the network 102 etc. In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The display 210 may display electronic images and data output by the computing system 200 for presentation to a user 112. The display 210 may include any conventional display device, monitor or screen, including, for example, an organic light-emitting diode (OLED) display, a liquid crystal display (LCD), etc. In some implementations, the display 210 may be a touchscreen display capable of receiving input from one or more fingers of a user 112. For example, the display 210 may be a capacitive touchscreen display capable of detecting and interpreting multiple points of contact with the display surface. In some implementations, the computing system 200 may include a graphics adapter (not shown) for rendering and outputting the images and data for presentation on display 210. The graphics adapter (not shown) may be a separate processing device including a separate processor and memory (not shown) or may be integrated with the processor 202 and memory 204.

The input device 212 may include any device for inputting information into the computing system 200. In some implementations, the input device 212 may include one or more peripheral devices. For example, the input device 212 may include a keyboard (e.g., a QWERTY keyboard), a pointing device (e.g., a mouse or touchpad), microphone, an image/video capture device (e.g., camera), etc. In some implementations, the input device 212 may include a touchscreen display capable of receiving input from the one or more fingers of the user. For instance, the structure and/or functionality of the input device 212 and the display 210 may be integrated, and a user of the computing system 200 may interact with the computing system 200 by contacting a surface of the display 210 using one or more fingers. In this example, the user could interact with an emulated (i.e., virtual or soft) keyboard displayed on the touchscreen display 210 by using fingers to contact the display in the keyboard regions.

A recipe may be an integration flow that contains a trigger and a set of actions. It may include code and/or represented in a low-code or no-code environment. The trigger causes the actions in a recipe to be executed. Actions are the routines the recipe runs. Each action may include an input configuration and is associated with a given application (e.g., a third-party application 160). Each trigger and action may further include metadata, such as an input schema and an output schema. Actions may run in parallel, series, or various combinations thereof. In some instances, one action may be dependent upon the output of a preceding action. In a typical recipe configuration, the different actions in the recipe are associated with different applications, and the recipe automates the interaction between the different applications using the application programming interfaces (APIs) of those applications. For instance, the recipe may flow, sync, etc., data from one application to another, populate multiple different applications with data from a certain source application, etc. In some embodiments, the recipes are written in Ruby, and the secure containers 130 of the worker instances 128 interpret and process the recipes, although it should be understood that other languages and interpreters may be used. A workflow may include one or more recipes, for example.

In some implementations, one or more modules or engines, such as a workflow copilot 140, code and routines 214, or components may be included and may include computer logic storable in the memory 204 and executable by the processor 202, and/or implemented in hardware to provide its acts and/or functionality, such as the description herein. Other code and routines 214 may be used to provide other communication and functionality of the computing device 200. For instance, a workflow copilot 140 may include a machine learning or large language model or a decision or logic-based application that may provide or interact with a user via a chat or other user interface, for example, where a user may ask an AI assistant to perform an operation within a platform.

In some implementations, a workflow copilot 140 may include or may interface with an AI assistant, such as a second AI model or agent. A workflow copilot 140 may alternatively be referred to herein as an AI assistant, but it may interface with one or more AI assistants, or large language models, etc.

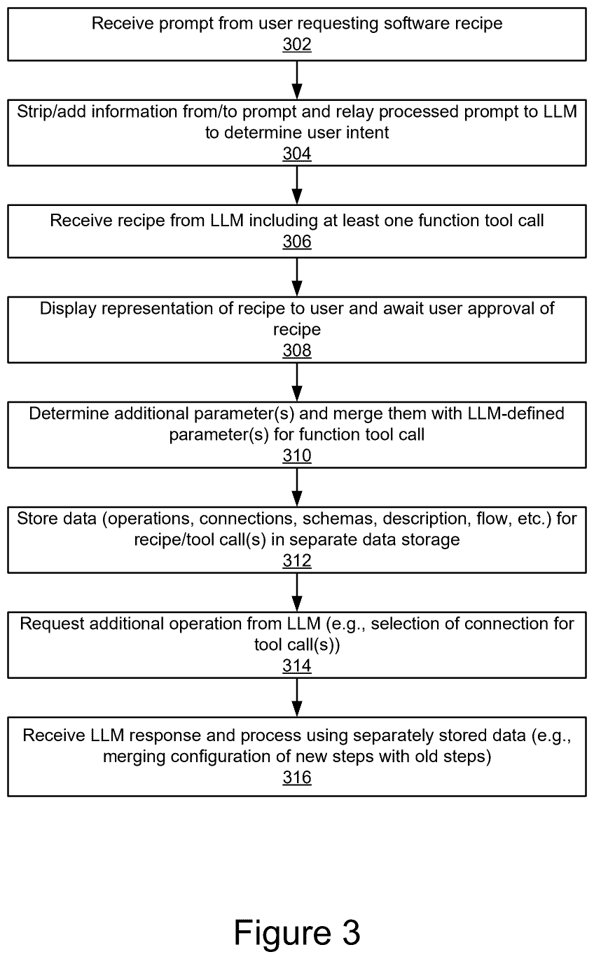

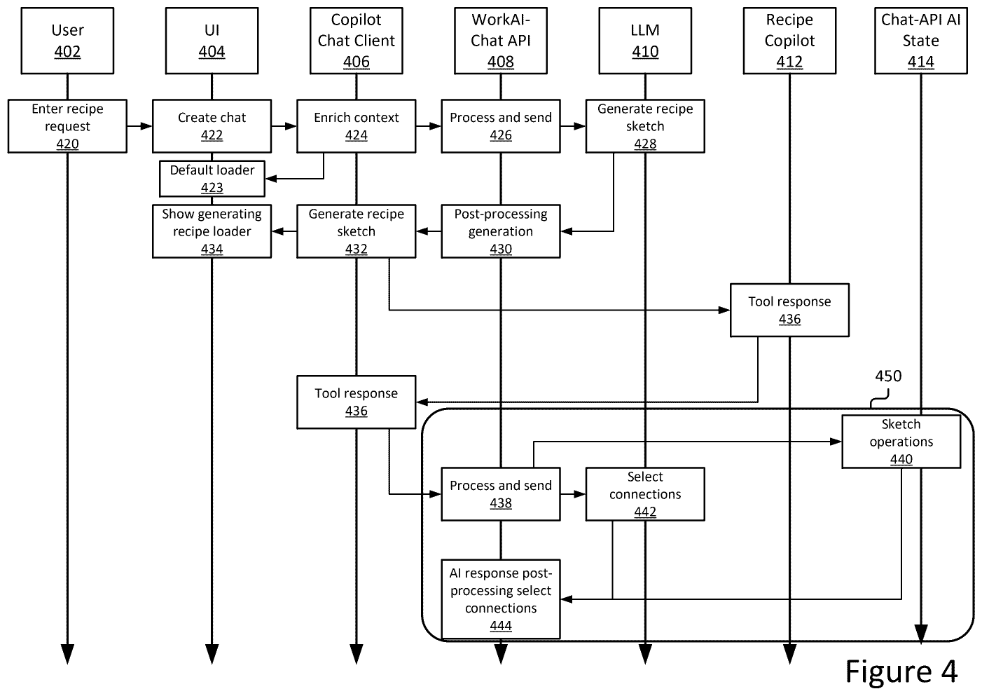

FIG. 3 illustrates an example method for passing parameters in artificial intelligence flows, according to some implementations. Additional and/or alternative details may be described elsewhere herein, such as above and in reference to FIG. 4. It should also be noted that these operations are illustrative examples, and that other operations, orders, features, and details are possible and contemplated herein.

As an example, a user may request that the workflow copilot 140 generate a recipe or flow/sketch for a recipe. For example, “please generate a recipe that logs time every five minutes”. The workflow copilot 140 may strip unnecessary information (e.g., “please generate a recipe that”) and relay the prompt to an LLM, which may be part of the workflow copilot 140. The LLM may recognize user intent to generate a recipe and call a tool name generator.

The recipe may include a set of connectors and actions to build the recipe. For example, the workflow copilot 140 may receive or determine parameters for the tools, such as connector(s), action(s), etc. The workflow copilot 140 may request that the user approve the recipe and then set a connection for the required operation(s) of the tool(s)/recipe. For instance, a connection may require some or all operations as an input. In order to avoid passing all of the operations or other parameters to the LLM (for data security and/or token savings), the workflow copilot 140 may omit parameters, arguments, values, files, etc., and perform separate processing for those operations. For example, if a recipe had 100 elements in a JSON object, it would be undesirable to pass the entire JSON object to the LLM. Instead, the workflow copilot 140 may take an output of the recipe tool call or response and pass it directly to the input of the next tool call (e.g., without asking the LLM to generate inputs for this tool call). In some implementations, the workflow copilot 140 may pass values or parameters directly between tools without including those values or parameters in any LLM prompt or context.

For example, the user may indicate “please summarize all of my Jira issues.” The LLM may determine that it needs to receive Jira™ issues then pass the issue details to the next tool call, which may, for instance, be a tool to summarize the issue.

In another example, a recipe may greet a user (e.g., “Hello, John”), but the workflow copilot 140 may hide the username from the LLM. Instead, the workflow copilot 140 may use a tool to retrieve or otherwise determine the username. The LLM would not configure a user ID, but the workflow copilot 140 may add a user ID argument on a post processing stage to the LLM response. For instance, the LLM may select a suitable tool (e.g., “get_username”), but it would not configure the user ID argument, instead the workflow copilot 140 may add the argument in the post processing stage, accordingly, hiding the username or other personal information from the LLM. In some implementations, the workflow copilot 140 may hide an argument (whether or not requested by an LLM) from the LLM to avoid the LLM configuring the argument. Accordingly, the workflow copilot 140 may allow some arguments to be used by a tool or between tools (and not the LLM) while other arguments are used by the LLM and/or the tools.

In some implementations, at 302, the workflow copilot 140 may receive a prompt from a user requesting software recipe. For example, the user may provide a natural language prompt in a conversational/chat interface. The workflow copilot 140 may recognize the prompt (e.g., it may start with @copilot) and begin processing.

In some implementations, at 304, the workflow copilot 140 may strip and/or add information from/to the prompt and relay the processed prompt to an LLM to determine user intent. In some instances, there may be a defined set of extraneous information that is automatically stripped (e.g., “Would you please do the following”, etc.) by the workflow copilot 140 (or a recipe, separate software process, etc.). In some instances, there may be other information that the workflow copilot 140 fills in, such as where the copilot recognizes a certain type of prompt or message and automatically augments it based on previously provided prompts or administrator-defined logic to improve it or provide additional context to the LLM. For instance, the workflow copilot 140 may append context to the prompt. In some implementations, the relayed prompt may include a function call requesting arguments or parameters from the LLM.

In some implementations, at 306, the workflow copilot 140 may receive information (e.g., for a recipe) from an LLM and/or details for at least one function tool call (e.g., for the recipe or other tool). For instance, the message from the LLM may request information from a tool for the prompt, which may include parameters or arguments for the tool call. These may be based on the original or processed prompt sent to the LLM. In some implementations, the received message from the LLM may be displayed to a user or may seek replies to the arguments in the background before the workflow copilot 140 displays the LLM response. The workflow copilot 140 may display a graphical notification that a response is being generated.

In some implementations, at 308, the workflow copilot 140 may display a representation of the recipe to the user and await user approval of recipe. For instance, the displayed representation of the recipe may be pseudocode, a flowchart, code, an outline, or other details indicating functionality of the recipe. In some cases, the workflow copilot 140 may process the function calls in the background prior to seeking user approval or may seek user approval in configuring each tool/function/connection, for example.

In some implementations, at 310, the workflow copilot 140 may determine one or more additional parameters and may merge them with the LLM-defined parameters for at least one function tool call. For instance, the workflow copilot 140 may add parameters to those requested by the LLM based on the requested tool, later tools, or earlier tools in the flow. For example, the workflow copilot 140 may add a username argument, which the requested tool may use to identify a certain user.

In some implementations, at 312, the workflow copilot 140 may store data (operations, connections, schemas, description, flow, etc.) for recipe/tool call(s) in data storage, which may be separate, for example, for data security or separate usage. For instance, the workflow copilot 140 may store a JSON file of the output of a first tool, its operations, connections, etc., in a data store accessible to the workflow copilot 140 and/or other tools.

For instance, the tool may provide a response for the recipe, which response may include connectors (e.g., to a service, a clock, an API, etc.), an action (e.g., a scheduled_event, etc.), a connector (e.g., a logger), an action (e.g., log_message), etc. Some of these data items or parameters may be stored or passed to the LLM in a subsequent step/operation. For instance, those that are not necessary for the next step or that are private may be stored and/or withheld by the workflow copilot 140 (e.g., for the next step).

In some implementations, at 314, the workflow copilot 140 may request one or more additional operations from the LLM, such as a selection of connection for tool call(s). For instance, the workflow copilot 140 may send a prompt to the LLM to configure a subsequent step or tool in the recipe/flow. In some cases, some of the arguments may be sent to the LLM (e.g., based on the prompts, the outputs of a previous tool, logic from the workflow copilot 140, stored data, user inputs, or otherwise) while others (e.g., some or all of the operations or outputs from the previous tool from which this tool depends) may be withheld by the workflow copilot 140. For example, an LLM may be used to determine intent or match unstructured data. For example, the prior tool may have output a JSON file from a first connection indicating the user's sales data. The workflow copilot 140 may store the JSON file but request that the LLM configure a second tool that uses (e.g., automatically emails to a user) sales data of a user, so that it configures the tool without knowing the data. As noted elsewhere herein, the workflow copilot 140 may replace a placeholder or portion of the output of the second tool (e.g., using an LLM) using the retained sales data, so that the sales data itself is never seen by the second tool or LLM.

In some implementations, at 316, the workflow copilot 140 may receive an LLM response and process it using separately stored data (e.g., merging configuration of new steps with old steps). For instance, the workflow copilot 140 may add arguments from a database or an earlier tool to the inputs for the subsequently called tool. In other instances, the workflow copilot 140 may add a JSON file or other data file that passes the data directly to a tool and/or passes data for/from the first tool directly to a second tool. Accordingly, while the LLM may determine user intent and/or configurations, etc., the workflow copilot 140 may omit part of the configuration or passage of data, instead configuring the tools or connections directly instead of asking the LLM to process that data and/or configure it. For example, it may pass values for certain parameters directly from a first tool (e.g., an output of a first tool) to a next tool (e.g., an input or configurations, etc., thereof). For instance, a workflow copilot 140 may insert an argument or tool for determining a username into a recipe and the associated username or user ID may be used in multiple tools (e.g., for establishing connections to tools or third-party services), potentially where those other tools use only the placeholder for the user ID and the first tool or workflow copilot 140 fills in the actual user ID, depending on the implementation and configuration.

These and other operations may be repeated or performed differently, for example, as additional operations of a flow/recipe are computed, completed, updated, or added. Additionally or alternatively, they may be used when a recipe is called that uses LLM inputs to determine user intent, summarize data, generate data, or convert data to natural language, for example. Accordingly, the operations for passing parameters through tools in a recipe instead of an LLM may be configured into the recipe at creation and/or used at runtime.

FIG. 4 illustrates a flowchart of example operations for passing determined parameters in artificial intelligence assistant flows. For instance, FIG. 4 illustrates a data communication flow between various components of the system, although other flows and steps may be possible, for example, various operations are shown being performed on certain devices or services, but it should be noted that other implementations are possible and contemplated. For example, some operations of the technology described above may be represented at the enclosed box in which data is processed, connections are selected, sketch JSON operations are passed, and post processing is performed on the LLM (e.g., which may select connections) response, for example, to select connections. For instance, deterministic parameters defined in a state may be passed to a chat API as part of a new flow or recipe instead of as part of an LLM call.

As illustrated in the example, data, such as a recipe JSON object, schemas for recipe parts, connections, etc., may be stored in data storage (e.g., not in LLM memory or LLM context) and merged with a function call JSON object in post processing of the LLM call.

The example method of FIG. 4 may perform post processing of LLM calls with data from a separate non-LLM-related storage, which stores the data in a format that can be merged with the results of the LLM call. For example, a recipe/workflow copilot 140 may update a five-step recipe, and it may use an LLM to generate two new steps to be integrated in the recipe flow. The five steps of the initial recipe (including connections, schemas, descriptions, and actual recipe flow) may be used for a step “generate updated recipe”. Information from the initial five steps can be stored in a separate state storage and merged with the two new steps in post processing of an LLM call by merging the configuration of the two new steps and the old five steps into a single entity.

In the depicted example of FIG. 4, operations may be performed by various entities, such as a user 402; a user interface 404; a recipe or workflow copilot 140 chat client 406, which may be a chat client of a workflow copilot 140; a workflow copilot AI model chat/workAI-chat API 408, which may represent an API between the workflow copilot 140 and an AI service/LLM; an LLM 410 (or other AI model); and a workflow copilot 140 or recipe copilot 412, which may be a copilot that creates and/or uses recipes, etc., as noted elsewhere herein. FIG. 4 also calls out the chat API AI state at 414. While these steps, communications, and components are illustrated, others are possible using the technology described herein. Furthermore, it should be noted that the components and operations described in reference to FIG. 4 may correspond to the others described herein.

At 420, the user 402 may provide a recipe request, which may include a request to create and/or use a software recipe. The request may be received in a user interface 404 at 422, for example, where the request is received in a chat interface. The UI 404 may be accessed, or data may be received from the UI 404 by the copilot chat client 406. In some cases, the enriched context may additionally or alternatively be passed to the UI 404, for example, a default loader at 423.

At 424, the copilot chat client 406 may enrich the context of the chat prompt, such as by accessing previous recipes or tool calls, accessing user preferences, or by replacing references to confidential information (e.g., with placeholders or other information), etc., as noted elsewhere herein. For instance, confidential information or other information may be defined by an administrator to be restricted from external LLM access. The copilot chat client 406 may pass the enriched prompt through the API 408, which may process and send the prompt at 426.

In some implementations, at 428, the LLM 410 may use the enriched prompt to generate a recipe sketch, which may include a recipe, code, an outline of a recipe, or other responses. The LLM 410 may use various tools to determine user intent, generate a recipe, or perform other actions.

At 430, the workAI-chat API may receive the recipe sketch and/or other output from the LLM 410, and it may perform post processing, and it may perform post processing on the AI response, such as the generated recipe (determined based on the user's intent). The post processing may include various operations, such as those described elsewhere herein, and it may format or otherwise process the response to be used by other components, such as the copilot chat client 406.

At 432, the copilot chat client 406 may generate a recipe sketch using the response, the determined user intent, and/or other data. In some implementations, as noted elsewhere herein, the copilot chat client 406 and/or workflow copilot 140 may replace place holders, add previously determined steps, add other proprietary data, or perform other operations to generate the recipe sketch. In some implementations, it may format or make various other changes to prepare the recipe to be displayed in the UI 404 and/or executed by the web server 120, a client application 108, and/or another device.

In some implementations, the generated recipe sketch may be displayed, at 434, in the UI 404, and/or it may display a loading message. For instance, a loader may be shown stating “generating recipe.”In some implementations, the generated recipe sketch may be passed to the recipe copilot 412, which may, at 436 determine a tool response, for example, to determine details of the sketch, JSON file, operations, etc. In some implementations, the recipe copilot 412 may augment the generated recipe sketch, for example, by determining details for a tool used by an operation of the recipe. In some implementations, it may also add data that was withheld from the LLM 410, as noted elsewhere herein. At 436, the tool response may be returned to the copilot chat client 406, which may further augment, use, or display it.

At 438, the workAI-chat API 408 may receive the recipe, for example, which may include the tool response(s), such as the recipe including parameters, arguments, operations, or other details that may be used by the tool(s) called in the recipe, although other implementations are possible. The workAI-chat API 408 may process and send the sketch and/or other details to the LLM 410. At 440, the system, such as a chat-API AI state 414 may allow one or more operations of the sketch recipe (e.g., represented in JSON format) to be determined and/or performed.

At 442, the LLM may select one or more connections for the recipe. For instance, it may determine connections to one or more tools or other applications to complete operations of the recipe, for example, to flesh out details of the recipe. In some implementations, the workAI chat API 408, or another component, may store deterministic parameters (e.g., determined by selecting connections 442 and/or the sketch operations 440) in separate state storage and process it at 444.

In some implementations, at 444, the workAI chat API 408 may perform post processing on the AI response and selected connections, for example, to complete, verify, or use them. In some cases, it may pass the post-processed recipe or other information to the copilot chat client 406 or another component for display or use by the user.

Additionally, as noted above, the box 450 may represent operations of the technology described elsewhere herein. For example, some operations of the technology described above may be represented at the enclosed box in which data is processed, connections are selected, sketch JSON operations are passed, and post processing is performed on the LLM (e.g., which may select connections) response, for example, to select connections. For instance, deterministic parameters defined in a state may be passed to a chat API as part of a new flow or recipe instead of as part of an LLM call.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services. Thus, it should be understood that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the described system(s) may be integrated into to a single computing device or system or additional computing devices or systems, etc. In addition, while the system depicted herein provides an example of an applicable computing architecture, it should be understood that any suitable computing architecture, whether local, distributed, or both, may be utilized in the system.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to a computing device and/or other apparatus for performing the operations herein. This computing device may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Communication unit(s) (e.g., network interfaces, etc.) may also be coupled to the system to enable the data processing system to become coupled to other data processing systems, storage devices, remote printers, etc., through intervening private and/or public networks, such as the network 102.

Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a collection of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
generating, by one or more processors, a software recipe, the software recipe including one or more triggers and one or more actions, at least one of the one or more actions including one or more function tool calls;
determining, by the one or more processors, a first set of parameters for the one or more function tool calls;
determining, by the one or more processors, a second set of parameters for the one or more function tool calls, the second set of parameters being determined by one or more artificial intelligence (AI) models;
merging, by the one or more processors, the first set of parameters and the second set of parameters for the one or more function tool calls, the one or more function tool calls using the first set of parameters and the second set of parameters to perform the one or more actions; and
executing, by the one or more processors, the software recipe using the one or more function tool calls.

2. The computer-implemented method of claim 1, further comprising:
receiving, by the one or more processors, a prompt requesting a generation of the software recipe;
processing, by the one or more processors, the prompt including stripping data from the prompt; and
relaying, by the one or more processors, the processed prompt to the one or more AI models to determine user intent for the software recipe.

3. The computer-implemented method of claim 2, further comprising:
receiving, by the one or more processors, the software recipe from the one or more AI models;
displaying, by the one or more processors, a graphical representation of the software recipe to a user in a graphical user interface; and
receiving, by the one or more processors, an approval of the software recipe by the user.

4. The computer-implemented method of claim 2, wherein stripping the data from the prompt includes:
removing, by the one or more processors, at least one parameter of the first set of parameters from the prompt.

5. The computer-implemented method of claim 1, further comprising:
determining, by the one or more processors, an output for a previous function tool call;
determining, by the one or more processors, the first set of parameters based on the output for the previous function tool call; and
using, by the one or more processors, the first set of parameters in an input for the one or more function tool calls.

6. The computer-implemented method of claim 1, wherein:
the first set of parameters includes one or more data points defined to be restricted from being accessed by the one or more AI models.

7. The computer-implemented method of claim 6, wherein:
the first set of parameters includes a user identifier used in the software recipe, the one or more processors determining the user identifier at run time of the software recipe.

8. The computer-implemented method of claim 1, wherein:
the first set of parameters includes one or more previously defined parameters by the one or more AI models for a previous software recipe, the one or more previously defined parameters defining a connection with a separate application.

9. The computer-implemented method of claim 1, wherein executing the software recipe using the one or more function tool calls includes:
performing, by the one or more processors, post processing on a response from the one or more AI models using a previously determined parameter, the first set of parameters including the previously determined parameter.

10. The computer-implemented method of claim 1, wherein executing the software recipe using the one or more function tool calls includes:
injecting, by the one or more processors, the first set of parameters into the one or more function tool calls.

11. A system comprising:
one or more processors; and
a computer-readable memory storing instructions that, when executed by the one or more processors, cause the system to perform operations comprising:
generating, by the one or more processors, a software recipe, the software recipe including one or more triggers and one or more actions, at least one of the one or more actions including one or more function tool calls;
determining, by the one or more processors, a first set of parameters for the one or more function tool calls;
determining, by the one or more processors, a second set of parameters for the one or more function tool calls, the second set of parameters being determined by one or more artificial intelligence (AI) models;
merging, by the one or more processors, the first set of parameters and the second set of parameters for the one or more function tool calls, the one or more function tool calls using the first set of parameters and the second set of parameters to perform the one or more actions; and
executing, by the one or more processors, the software recipe using the one or more function tool calls.

12. The system of claim 11, wherein the operations further comprise:
receiving, by the one or more processors, a prompt requesting a generation of the software recipe;
processing, by the one or more processors, the prompt including stripping data from the prompt; and
relaying, by the one or more processors, the processed prompt to the one or more AI models to determine user intent for the software recipe.

13. The system of claim 12, wherein the operations further comprise:
receiving, by the one or more processors, the software recipe from the one or more AI models;
displaying, by the one or more processors, a graphical representation of the software recipe to a user in a graphical user interface; and
receiving, by the one or more processors, an approval of the software recipe by the user.

14. The system of claim 12, wherein stripping the data from the prompt includes:
removing, by the one or more processors, at least one parameter of the first set of parameters from the prompt.

15. The system of claim 11, wherein the operations further comprise:
determining, by the one or more processors, an output for a previous function tool call;
determining, by the one or more processors, the first set of parameters based on the output for the previous function tool call; and
using, by the one or more processors, the first set of parameters in an input for the one or more function tool calls.

16. The system of claim 11, wherein:
the first set of parameters includes one or more data points defined to be restricted from being accessed by the one or more AI models.

17. The system of claim 16, wherein:
the first set of parameters includes a user identifier used in the software recipe, the one or more processors determining the user identifier at run time of the software recipe.

18. The system of claim 11, wherein:
the first set of parameters includes one or more previously defined parameters by the one or more AI models for a previous software recipe, the one or more previously defined parameters defining a connection with a separate application.

19. The system of claim 11, wherein executing the software recipe using the one or more function tool calls includes:
performing, by the one or more processors, post processing on a response from the one or more AI models using a previously determined parameter, the first set of parameters including the previously determined parameter.

20. The system of claim 11, wherein executing the software recipe using the one or more function tool calls includes:
injecting, by the one or more processors, the first set of parameters into the one or more function tool calls.
